(19) United States
(12) Patent Application Publication
(10) Pub. No.: US 2014/0372107 A1
(43) Pub. Date: Dec. 18, 2014

(54) AUDIO PROCESSING

(71) Applicant: Nokia Corporation, Espoo (FI)

(72) Inventors: Miikka VILERMO, Siuro (FI); Lasse LAAKSONEN, NOKIA (FI); Adriana VASILACHE, Tampere (FI); Toni MÄKINEN, Tampere (FI); Roope JÄRVINEN, Lempaala (FI)

(21) Appl. No.: 14/298,809

(22) Filed: Jun. 6, 2014

(30) Foreign Application Priority Data
Jun. 14, 2013 (GB) 1310597.8

(51) Int. Cl. G10L 19/26; G10L 19/02

(52) U.S. Cl. CPC G10L 19/265; G10L 19/0204
USPC 704/205

(57) ABSTRACT

A technique for creating audio objects on basis of a source audio signal is provided. According to an example embodiment, the technique comprises obtaining a plurality of frequency sub-band signals, each representing a directional component of a source audio signal in the respective frequency sub-band, obtaining an indication of dominant sound source direction for one or more of said frequency sub-band signals, and creating one or more audio objects on basis of said plurality of frequency sub-band signals and said indications, said creating comprising deriving one or more audio object signals, each audio object signal comprising a respective directional signal determined on basis of frequency sub-band signals for which dominant sound source direction falls within a respective predetermined range of source directions and deriving one or more audio object direction indications for said one or more audio object signals, each audio object direction indication derived on basis of dominant sound source directions for the frequency sub-band signals used for determining the respective directional signal.

### TECHNICAL FIELD

The example and non-limiting embodiments of the present invention relate to processing of audio signals. In particular, at least some example embodiments relate to a method, to an apparatus and/or to a computer program for providing one or more audio objects on basis of a source audio signal.

### BACKGROUND

Object oriented audio formats have recently emerged. Examples of such formats may include DOLBY ATMOS by DOLBY LABORATORIES INC., Moving Pictures Expert Group Spatial Audio Object Coding (MPEC SAOC) and AURO 3D by AURO TECHNOLOGIES.

Object oriented audio formats provide some benefits over conventional audio downmixes that assume a fixed predetermined channel and/or loudspeaker configuration. For an end-user probably an important benefit may be the ability to play back the audio using any equipment and any loudspeaker configuration whilst still achieving a high audio quality, which may not be the case when using traditional audio downmixes relying on a predetermined channel/loudspeaker configuration, such as ones according to the 5.1 channel surround/spatial audio.

For example object oriented audio formats may be played using equipment such as use headphones, 5.1 surround audio in a home theater, mono/stereo speakers in a television set or speakers of a mobile device such as a mobile phone or a portable music player and the like.

An audio object according to an object oriented audio format is typically created by recording the sound corresponding to the audio object separately from any other sound sources to avoid incorporating ambient components to the actual directional sound representing the audio object. In practice, such recordings are mostly carried out in anechoic conditions, e.g. in studio conditions, employing well-known microphone setup.

Such recording conditions and/or equipment are typically not available for end-users. Therefore, it would be advantageous to provide an audio processing technique that enables creating audio objects according to an object oriented audio format on basis of a pre-recorded audio signals and/or on basis of audio signal recorded using equipment and conditions that are readily available for the general public.

### SUMMARY

According to an example embodiment, an apparatus is provided, the apparatus comprising at least one processor and at least one memory including computer program code for one or more programs, the at least one memory and the computer program code configured to, with the at least one processor, cause the apparatus at least to obtain a plurality of frequency sub-band signals, each representing a directional component of a source audio signal in the respective frequency sub-band, to obtain an indication of dominant sound source direction for one or more of said frequency sub-band signals, and to create one or more audio objects on basis of said plurality of frequency sub-band signals and said indications, said creating comprising deriving one or more audio object signals, each audio object signal comprising a respective directional signal determined on basis of frequency sub-band signals for which dominant sound source direction falls within a respective predetermined range of source directions and deriving one or more audio object direction indications for said one or more audio object signals, each audio object direction indication derived on basis of dominant sound source directions for the frequency sub-band signals used for determining the respective directional signal.

According to another example embodiment, another apparatus is provided, the apparatus comprising means for obtaining a plurality of frequency sub-band signals, each representing a directional component of a source audio signal in the respective frequency sub-band, means for obtaining an indication of dominant sound source direction for one or more of said frequency sub-band signals, and means for creating one or more audio objects on basis of said plurality of frequency sub-band signals and said indications, the means for creating arranged to derive one or more audio object signals, each audio object signal comprising a respective directional signal determined on basis of frequency sub-band signals for which dominant sound source direction falls within a respective predetermined range of source directions and to derive one or more audio object direction indications for said one or more audio object signals, each audio object direction indication derived on basis of dominant sound source directions for the frequency sub-band signals used for determining the respective directional signal.

According to another example embodiment, a method is provided, the method comprising obtaining a plurality of frequency sub-band signals, each representing a directional component of a source audio signal in the respective frequency sub-band, obtaining an indication of dominant sound source direction for one or more of said frequency sub-band signals, and creating one or more audio objects on basis of said plurality of frequency sub-band signals and said indications, said creating comprising deriving one or more audio object signals, each audio object signal comprising a respective directional signal determined on basis of frequency sub-band signals for which dominant sound source direction falls within a respective predetermined range of source directions and deriving one or more audio object direction indications for said one or more audio object signals, each audio object direction indication derived on basis of dominant sound source directions for the frequency sub-band signals used for determining the respective directional signal.

According to another example embodiment, a computer program is provided, the computer program including one or more sequences of one or more instructions which, when executed by one or more processors, cause an apparatus at least to obtain a plurality of frequency sub-band signals, each representing a directional component of a source audio signal in the respective frequency sub-band, to obtain an indication of dominant sound source direction for one or more of said frequency sub-band signals, and to create one or more audio objects on basis of said plurality of frequency sub-band signals and said indications, said creating comprising deriving one or more audio object signals, each audio object signal comprising a respective directional signal determined on basis of frequency sub-band signals for which dominant sound source direction falls within a respective predetermined range of source directions and deriving one or more audio object direction indications for said one or more audio object signals, each audio object direction indication derived on basis of dominant sound source directions for the frequency sub-band signals used for determining the respective directional signal.

The computer program referred to above may be embodied on a volatile or a non-volatile computer-readable record medium, for example as a computer program product comprising at least one computer readable non-transitory medium having program code stored thereon, the program which when executed by an apparatus cause the apparatus at least to perform the operations described hereinbefore for the computer program according to the fifth aspect of the invention.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings.

FIG. 1 schematically illustrates the concept of spatial/directional hearing.

FIG. 2 schematically illustrates an arrangement for providing audio processing according to an example embodiment.

FIG. 3 schematically illustrates an audio mixer according to an example embodiment.

FIG. 4 illustrates a method according to an example embodiment.

FIG. 5 schematically illustrates an arrangement for providing audio processing according to an example embodiment.

FIG. 6 schematically illustrates an exemplifying microphone setup.

FIG. 7 illustrates a method according to an example embodiment.

FIG. 8a illustrates a method according to an example embodiment.

FIG. 8b illustrates a method according to an example embodiment.

FIG. 9 schematically illustrates an audio processing entity according to an example embodiment.

FIG. 10 schematically illustrates an arrangement for providing audio processing according to an example embodiment.

FIG. 11 schematically illustrates an exemplifying apparatus in accordance with an example embodiment.

### DESCRIPTION OF SOME EMBODIMENTS

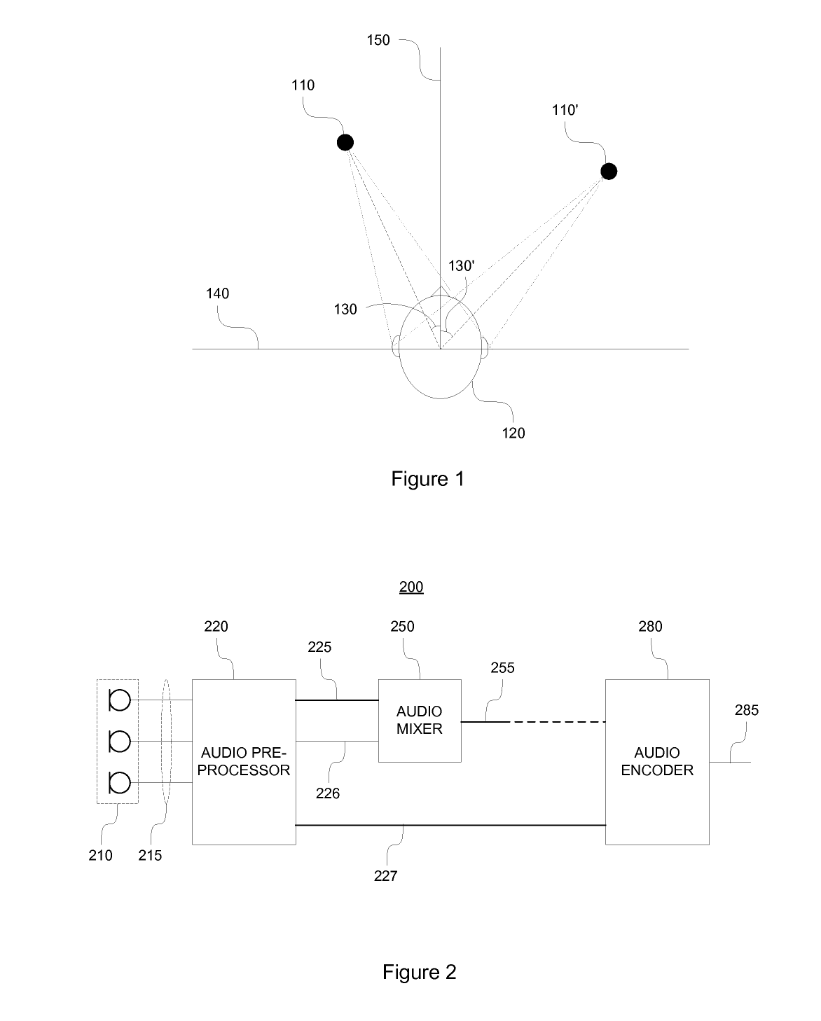

FIG. 1 schematically illustrates the concept of spatial or directional hearing. A listener 120, depicted directly from above, receives a sound originating from a sound source 110 that is in a left side in front of the listener 120 and another sound from a sound source 110′ that is in a right side in front of the listener 120. As the example indicates, the distance from the sound source 110 to the left ear of the listener 120 is shorter than the distance from the sound source 110 to the right ear of the listener 120, consequently resulting in the sound originating from the sound source 110 being received at the left ear of the listener 120 slightly before the corresponding sound is received at the right ear of the listener 120. Moreover, due to the longer distance, and also due to the head of the listener being in the way between the sound source 110 and the right ear, sound originating from the sound source 110 is received at the right ear at a slightly lower signal level than at the left ear. Hence, the differences both in time of reception and in level of received sound occur due to the distance from the sound source 110 to the left ear being shorter than to the right ear. For the sound source 110′ that is on the right side of the listener 120 the situation is quite the opposite: due to longer distance to the left ear than to the right ear of the listener 120, a sound originating from the sound source 110′ is received at the left ear slightly after reception at the right ear and at a slightly lower level than at the right ear. Conversely, the time and level differences between the sounds received at the left and right ears are indicative of the direction of arrival (or direction, in short) of the respective sound and hence the spatial position of the respective sound source 110, 110′.

While illustrated in FIG. 1 by using the human listener 120 as an example, the discussion regarding the time and level differences equally applies to a microphone array arranged at the position of the listener 120, e.g. at the position where the coordinate lines 140 (“x axis”) and 150 (“y-axis”) intersect: a first microphone of the array that is more to the left in direction of the line 140 than a second microphone of the array receives the sound from the sound source 110 earlier and at a higher signal level than the second microphone, while the first microphone receives the sound from the sound source 110′ later and at a lower signal level than the second microphone. Consequently, the audio signals captured by the first and second microphones exhibit the time and level differences described hereinbefore by using the sound sources 110 and 110′ as examples. As an example, such a microphone array may consist of two microphones (e.g. to model hearing by the left and right ears), or such a microphone array may comprise more than two microphones in a desired geographical configuration. In the latter scenario, any pair of audio signals captured by the microphones of the array exhibit the time and level differences that depend on the relative distances of the respective microphones from the corresponding sound source 110, 110′. The position of the listener and/or the position of the microphone array with respect to the sound source 110, 110′ positions may be referred to as the (assumed) listening point.

The time and/or level differences between a pair of audio signals representing the same sound source may be characterized e.g. by an inter-aural level difference (ILD) and/or an inter-aural time difference (ITD) between audio signals. In particular, the ILD and/or ITD may characterize level and time differences e.g. between two channels of a stereophonic audio signal or between a pair of channels of a multi-channel audio signal, such as a 5.1 channel surround audio signal. With such a model/assumption the signal perceived at the right ear of the listener may be represented as a time-shifted and/or scaled version of the signal perceived at the left ear of the listener—and/or vice versa—where the extent of time-shift/scaling is characterized using the parameters ITD and/or ILD. Methods for deriving the parameters ITD and/or ILD on basis of a pair of audio signals are known in the art.

While the parameters ITD and/or ILD serve as indication(s) regarding the directional component represented by the pair of audio signals, it may be more convenient to express the direction of arrival as angle with respect to a reference direction, for example as an angle between the direction of arrival and a center axis represented by the line 150 in FIG. 1, e.g. as an angle 130 for the sound source 110 and/or as an angle 130′ for the sound source 110′. While various techniques may be applied to determine the angles 130, 130′, one approach involves using a mapping between the values of the ITD and/or ILD and the respective angle 130, 130′. Such a mapping between the value of ITD and/or ILD and the respective angle 130, 130′ may be determined e.g. on basis of the known relative positions of the microphones of the microphone array and/or on experimental basis. Hence, the ITD, ILD and/or the angle between the direction of arrival and the center axis may be considered as parameters representative the sound source direction with respect to the assumed listening point in a horizontal plane (defined by the lines/axes 140 and 150). The ITD, ILD and the angles 130, 130′ serve as non-limiting examples of parameters indicative of the sound source direction in an audio image.

Depending on the characteristics of the respective sound source 110, 110′, the ITD, ILD and/or the angles 130, 130′ may be frequency dependent, thereby suggesting possibly different values of the ITD, ILD and/or the angles 130, 130′ (or other parameters indicative of a sound source direction) at different frequency sub-bands of the audio signal. Moreover, due to the movement of the sound source 110, 110′ and/or the microphone array capturing the audio signals (and/or due to the movement of the listener 120) the values of the ITD, ILD and/or the angles 130, 130′ may vary over time. Therefore, the ITD, ILD and/or the angles 130, 130′ may be determined or indicated separately for a number of temporal segments of the pair of audio signals—typically referred to as frames or time frames.

Hence, for a given sound source in a given frame of the pair of audio signals, an ILD, ITD and/or the angle 130, 130′ may be determined for a number of frequency sub-bands to indicate the respective direction of arrival of a sound. In particular, for a given sound source in a given frame of the pair of audio signals divided into a number of frequency sub-bands covering the frequency band of interest, an ILD, ITD and/or the angle 130, 130′ may be determined for only some of the frequency sub-bands. As an example, ITD parameter may be considered as a dominant contributor to the perceived direction of arrival of a sound source at low frequencies, hence suggesting that an ITD may be determined only for a predetermined range of the lower frequencies (e.g. up to 2 kHz). Moreover, depending on the characteristics of a given sound source, it may not be possible to identify a directional component in some of the frequency sub-bands e.g. due to lack of active signal component at respective frequency sub-bands and hence it may not be possible to determine an ITD, an ILD and/or the angle 130, 130′ for such frequency sub-bands either.

FIG. 2 schematically illustrates an audio processing arrangement 200 for converting an audio signal into one or more audio objects according to an embodiment. The arrangement 200 comprises a microphone array 210 for capturing a set of source audio signals 215. The set of source audio signals 215 may also be considered as the channels of a single source audio signal 215. The arrangement 200 further comprises an audio pre-processor 220 for determining, on basis of the set of source audio signals 215, a primary audio signal 225 representing a directional component in the source audio signals 215 and for determining indications of dominant sound source direction(s) 226 in an audio image represented by the source signals 215. The audio pre-processor 220 may be further arranged to determine one or more supplementary audio signals 227 representing the ambient component of the source audio signals 215. The arrangement 200 further comprises an audio mixer 250 for deriving one or more audio objects 255 on basis of the primary audio signal 225 and the indications of the dominant sound source directions. The arrangement 200 further comprises an audio encoding entity 280 for spatial audio encoding on basis of the one or more audio objects 255 and possibly further on basis of the supplementary audio signal(s) 227 to provide respective encoded audio objects 285.

The arrangement 200 described hereinbefore exemplifies the processing chain from the audio capture by the microphone array 210 until provision of the audio objects 255 and possibly the supplementary audio signals 227 to the audio encoding entity 280 for encoding and subsequent audio decoding and/or audio rendering. Hence, the arrangement 200 enables on-line conversion of the source audio signals 215 into one or more encoded audio objects 285. The arrangement 200 may be, however, varied in a number of ways to support different usage scenarios.

As an example in this regard, the microphone array 210 may be arranged to store the source audio signals 215 in a memory for subsequent access and processing by the audio pre-processor 220 and the further components in the processing chain according to the arrangement 200. Alternatively or additionally, the audio pre-processor 220 may be arranged to store the primary audio signal 225 and the direction indications 226 in a memory for subsequent access and processing by the audio mixer 250 and the further components in the processing chain according to the arrangement 200. Along similar lines, the audio pre-processor 220 may be arranged to store the supplementary audio signal(s) 227 in a memory for further access and processing by the audio encoding entity 280. As a yet further example, alternatively or additionally, the audio mixer 250 may be arranged to store the audio objects 255 into a memory for subsequent access and processing by the audio encoding entity 280. Such variations of the arrangement 200′ may enable scenarios where the source audio signals 215 are captured, possibly processed to some extent, and stored into a memory for subsequent further processing—thereby enabling off-line generation of the encoded audio objects 285.

The arrangement 200 may be provided in an electronic device. The electronic device may be e.g. a mobile phone, a (portable) media player device, a (portable) music player device, a laptop computer, a desktop computer, a tablet computer, a personal digital assistant (PDA), a camera or video camera device, etc. The electronic device hosting the arrangement 200 further comprises control means for controlling the operation of the arrangement 200. The arrangement 200 may be provided by software means, by hardware means or by combination of software and hardware means. Hence, the control means may be provided e.g. as software portion arranged to control the operation of the arrangement 200 or as dedicated hardware portion arranged to control the operation of the arrangement 200.

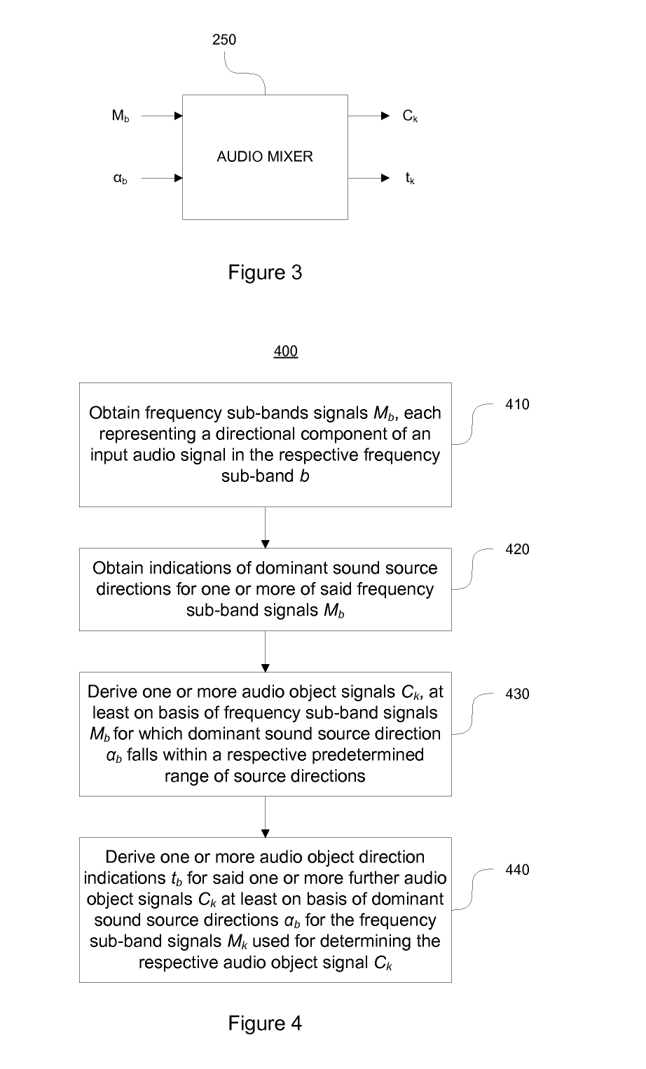

FIG. 3 schematically illustrates the audio mixer 250 for converting an audio input signal into one or more audio objects according to an example embodiment.

The audio mixer 250, preferably, obtains and processes the input audio signal 225 and the indications of dominant sound source directions 226 in time frames of suitable duration. As a non-limiting example, the processing may be carried out for frames having temporal duration in the range from 5 to 100 ms (milliseconds), e.g. 20 ms. In the following, however, explicit references to individual time frames are omitted both from the textual description and from the equations for clarity and brevity of description.

The audio mixer 250 is configured to obtain the primary audio signal 225 as an input audio signal M. The input audio signal M, preferably, represents a directional audio component of the source audio signal 215. The input audio signal M may be obtained as pre-arranged into a plurality of frequency sub-band signals M_{b}, each representing the directional audio component of the source audio signal 215 in the respective frequency sub-band b. Alternatively, the input audio signal M may be obtained as full-band signal, in other words as single signal portion covering all the frequency sub-bands of interest, and hence the audio mixer 250 may be configured to split the input audio signal M into frequency sub-band signals M_{b}.

The frequency range of interest may be divided into B frequency sub-bands. Basically any division to frequency sub-bands may be employed, for example a sub-band division according the Equivalent Rectangular Bandwidth (ERB) scale, as known in the art, or a sub-band division approximating the ERB scale.

The audio mixer 250 is further configured to obtain an indication of dominant sound source direction(s) 226 in the audio image represented by the source audio signal 215 as a set of angles α_{b} for one or more of said frequency sub-band signals M_{b}. Hence, each angle α_{b} indicates the dominant sound source direction for the respective frequency sub-band signal M_{b}. An angle α_{b} serves as an indication of the sound source direction with respect to a reference direction. The reference direction may be defined as the direction directly in front of the assumed listening point, e.g. as the center axis represented by the line 150 in the example of FIG. 1. Thus, as an example, angle 0° may represent the reference direction, positive values of the angle between 0° to 180° may represent directions that are on the right side of the center axis and negative values of the angle between 0° to −180° may represent direction that are on the left side of the center axis, with angle 180° (and/or) −180° representing the direction directly behind the assumed listening point.

The indication of the dominant sound source directions 226 may be provided for each of the frequency sub-band signals M_{b}, in other words for each of the B frequency sub-bands. Alternatively, the dominant sound source directions 226 may be provided for only predetermined portion of the frequency range, e.g. for a predetermined number of frequency sub-bands B_{α} such that B_{α}<B. Such an arrangement may be useful avoid handling of direction indications that are likely not beneficial for determination of the audio objects 255 and/or that indicate sound source directions for frequency sub-bands that are excluded from consideration in determination of the audio objects 255.

Alternatively or additionally, one or more indications of dominant sound source directions 226, e.g. one or more of the angles α_{b}, may be replaced by a predetermined indicator value that serves to indicate that there is no meaningful sound source direction available for the respective frequency sub-band signal. Such an indicator is referred herein as “null”, the value α_{b}=null hence indicating a directionless frequency sub-band signal, whereas the frequency sub-bands for which a meaningful dominant sound source direction has been provided may be referred to as directional frequency sub-band signals.

Typically, in a scenario where multiple sound sources are simultaneously active, the sounds originating therefrom exhibit different frequency characteristics. Consequently, in some frequency sub-bands the dominant audio signal content originates from a first sound source (e.g. the sound source 110 of FIG. 1) and hence the dominant sound source direction in the respective frequency sub-bands characterizes the direction/position of the first sound source with respect to the assumed listening point. On the other hand, in some other frequency sub-bands the dominant audio signal content originates from a second source (e.g. the sound source 110′ of FIG. 1), the dominant sound source direction in the respective frequency sub-bands thereby characterizing the direction/position of the second sound source with respect to the assumed listening point.

The audio mixer 250 is configured to create one or more audio objects 255 at least on basis of the frequency sub-band signals M_{b} and on basis of the angles α_{b}. Herein, an audio object 255 comprises an audio object signal Cₖ and a respective audio object direction indication tₖ. In other words, an audio object direction indication tₖ serves to indicate the sound direction (to be) assigned for the audio object signal Cₖ.

According to an example embodiment, the audio mixer 250 is configured to create at most a predetermined number K of audio objects. In this regard, a circle centered in assumed listening point in the horizontal plane (defined e.g. by the lines 140 and 150 in the example of FIG. 1), i.e. a horizontal circle, is divided into K non-overlapping sectors, each sector hence covering a predetermined range of source directions. As a non-limiting example, the horizontal circle may be divided into K=5 ranges rₖ, k=1 . . . 5 in the following way.

r₁=[−15, 15[

r₂=15, 70[

r₃=[70, 180[

r₄=[−180, −70[

r₅=[−70, −15[

While in this example the ranges rₖ cover the horizontal circle in full, the ranges may be defined such that some portions of the horizontal circle, i.e. one or more ranges of the angles between −180° and 180° are not covered. As a non-limiting example in this regard, the horizontal circle may be divided into three ranges rₖ′ in the following way.

r₁′=[−20, 20[

r₂′=[20, 75[

r₃′=[−75, −20[

In the following, for clarity and brevity of description, the creation of the audio objects 255 is described with reference to the ranges rₖ.

The audio mixer 250 is configured to assign each directional frequency sub-band signal, i.e. each frequency sub-band signal M_{b} having a meaningful dominant sound source direction assigned thereto, e.g. into one of the K ranges rₖ in accordance with the angle α_{b} provided therefor. The audio mixer 250 is further configured to derive directional signals C_{d,k} on basis of frequency sub-band signals M_{b} for which dominant sound source direction falls within a respective predetermined range rₖ of source directions. The number of frequency sub-band signals M_{b} assigned to the range rₖ may be denoted as nₖ.

The directional signals C_{d,k} may be derived as a combination of the frequency sub-band signals M_{b} assigned to the respective range, e.g. as a sum of the respective frequency sub-band signals according to equation (1)

C_{d,k}=Σ_{α}_{_{b}}_{εr}_{ₖ}M_{b} (1)

Consequently, the respective audio object signals Cₖ may be derived as Cₖ=C_{d,k}. In case a range rₖ has no frequency sub-band signals M_{b} assigned thereto, the audio mixer 250 may be configured to omit the respective audio object 255 altogether or the audio mixer 250 may be configured to set the respective directional signal to C_{d,k}=0.

According to an example embodiment, the audio mixer 250 may be further configured to derive a non-directional signal Cₙ on basis of the frequency sub-band signals M_{b} for which no direction of dominant source is indicated. This may include deriving the non-directional signal Cₙ on basis of only those frequency sub-bands M_{b} for which an explicit indication of no meaningful direction information being available has been obtained e.g. as α_{b}=null. Alternatively or additionally, this may involve deriving the non-directional signal Cₙ on basis of the frequency sub-band signals M_{b} for which no directional information is provided at all.

The non-directional signal Cₙ may be derived e.g. as a sum, as an average or as a weighted average of the of the respective frequency sub-band signals M_{b}. Moreover, the sum, the average or the weighted average may be scaled by a suitable scaling factor in order to provide the non-directional signal Cₙ at a suitable signal level. If, as an example, considering only those frequency sub-band signals M_{b} which are explicitly indicated not to carry meaningful direction information (i.e. for which α_{b}=null), the non-directional signal Cₙ may be determined as a sum of such frequency sub-band signals M_{b}, scaled by the number of ranges of source directions K according to equation (2)

$${C}_{n} = \frac{1}{K} {\sum }_{{α}_{b} = null} {M}_{b} . \qquad ( 2 )$$

In a further example, in case the audio objects 255 corresponding to ranges rₖ to which no frequency sub-band signals M_{b} assigned are omitted (as described hereinbefore as an option) the divisor Kin the equation (2) may be replaced e.g. by a parameter indicating the number of audio objects 255 actually provided from the audio mixer 250. In a yet further example, the divisor K in the equation (2) may be replaced e.g. by nₙ denoting the number of frequency sub-band signals M_{b} that are indicated not to carry meaningful direction information in order to determine the non-directional signal Cₙ as an average of the frequency sub-bands for which no directional information is provided.

Consequently, the audio object signals Cₖ may be derived as the combined contribution of the respective directional signal C_{d,k} and the non-directional signal Cₙ, e.g. as the sum

Cₖ=C_{d,k}+Cₙ. (3)

Basically, the output of the audio mixer 250 comprises K audio object signals, in which each of the K audio objects signals corresponds to a one of the ranges rₖ. However, in case one or more of the ranges rₖ have no frequency sub-band signals assigned thereto, the audio mixer 250 may be configured to omit the respective audio objects 255 from its output and thereby create and provide only the audio objects 255 corresponding to those ranges rₖ for which nₖ>0.

The audio mixer 250 is further configured to derive audio object direction indications tₖ for the respective audio object signals Cₖ. The direction indications tₖ are derived on basis of the dominant sound source directions for the frequency sub-band signals M_{b} used for determining the respective directional signals C_{d,k}. The audio object direction indications tₖ may be derived e.g. as an average or as a weighted average of the angles ab corresponding to the frequency sub-band signals M_{b} assigned for the respective range rₖ, e.g. according to equation (4)

$${t}_{k} = \frac{1}{{n}_{k}} {\sum }_{{α}_{b} ∈ {r}_{k}} {α}_{b} . \qquad ( 4 )$$

The audio mixer 250 is preferably arranged to obtain the audio input signal M and/or the plurality of frequency sub-band signals M_{b} as frequency domain signals, e.g. as Discrete Fourier Transform (DFT) coefficients covering the frequency range of interest, and hence to carry out any combination of frequency sub-band signals in the frequency-domain and, consequently, provide the audio object signals Cₖ of the resulting audio objects 255 as frequency-domain signals. Instead of providing the resulting audio object signals Cₖ as frequency-domain signals, the audio mixer 250 may be configured to transform the audio object signals Cₖ into time domain e.g. by applying inverse DFT.

As a further exemplifying alternative, the audio mixer 250 may be arranged to obtain the input audio signals as time domain signals, transform the obtained time domain input audio signals into frequency domain signals e.g. by applying DFT before processing the frequency sub-band signals M_{b}. Consequently, the resulting audio object signals Cₖ may be provided as frequency domains signals or time domain signals.

As a yet further alternative, the audio mixer 250 be arranged to receive, carry out the processing and provide audio object signals Cₖ as time-domain signals.

As pointed out hereinbefore, the input audio signal M preferably represents the directional component of the source audio signals 215. In particular, the input audio signal M preferably represents the directional component without the ambient component of the source audio signals 215. Such an arrangement may be provided e.g. by applying a mid/side decomposition (e.g. in the audio pre-processor 220) to the source audio signals 215, resulting in a mid-signal representing the directional component of the source audio signals 215 and a side-signal representing the ambient component of the source audio signals 215. Hence, the mid-signal may serve as the input audio signal M representing (or estimating) the directional component of the source signals 215. Consequently, the ambient component of the source audio signal 215 may be included in the supplementary audio signal(s) 227. However, the mid/side decomposition serves merely as a practical example of extracting a signal representing the directional component of the source audio signal 215 and any technique for extracting the directional signal component known in the art may be employed instead or in addition.

The input audio signal M is preferably a single-channel signal, e.g. a monophonic audio signal. However, instead of a single-channel signal, the audio mixer 250 may be configured to process a two-channel signal or a multi-channel signal of more than two channels. In such a scenario, the processing described in context of the equations (1) to (3) is repeated for each of the channels. Consequently, the audio mixer 250 may be e.g. configured to provide the audio object signals Cₖ as two-channel signals or multi-channel signals or configured to downmix the two-channel or multi-channel audio object signals Cₖ into respective single-channel audio object signals Cₖ before provision as the output of the audio mixer 250. Herein, the term downmix signal is used to refer to a signal created as a combination of two or more signals or channels, e.g. as a sum or as an average of the signals or channels.

The technique described hereinbefore in context of the audio mixer 250 may be also provided as a method carrying out the corresponding operations, procedures and/or functions. As an example, FIG. 4 illustrates a method 400 in accordance with an example embodiment. The method 400 comprises obtaining an input audio signal 225, e.g. a plurality of frequency sub-band signals M_{b}, each representing a directional component of a source audio signal 215 in the respective frequency sub-band b, as indicated in block 410. The method 400 further comprises obtaining indications of dominant sound source direction(s) 226 in an audio image represented by the source signals 215, e.g. as angles α_{b}, for one or more of said frequency sub-band signals M_{b}.

The method 400 further comprises creating one or more audio objects 255 on basis of said plurality of frequency sub-band signals M_{b} and said indications of dominant sound source direction(s) 226. The creation comprises deriving one or more audio object signals Cₖ, each audio object signal Cₖ derived at least on basis of frequency sub-band signals M_{b} for which dominant sound source direction falls within a respective predetermined range of source directions, as indicated in block 430. This may involve determining a directional signal C_{d,k} on basis of frequency sub-band signals M_{b} for which dominant sound source direction falls within the respective predetermined range of source directions and deriving the respective audio object signal Cₖ at least on bases of the directional signal C_{d,k}.

The creation further comprises deriving one or more audio object direction indications tₖ for said one or more audio object signals Cₖ, each direction indication tₖ derived at least on basis of dominant sound source directions 226, e.g. the angles α_{b}, for the frequency sub-band signals M_{b} used for determining the respective audio object signal Cₖ, as indicated in block 440. This may involve determining the audio object direction indications tₖ on basis of dominant sound source directions 226 indicated for the frequency sub-band signals M_{b} used for determining the respective directional signal C_{d,k}.

The operations, procedures and/or functions described in blocks 410 to 440 outlining the method 400 may be varied in a number of ways, as described hereinbefore in context of description of the corresponding operations, procedures and/or functions of the audio mixer 250.

In the following, an advantageous technique for creating a mid-signal as the primary audio signal 225 while at the same time also deriving the indications of dominant sound source directions 226 in an audio image represented by the source audio signals 215 is described. As mentioned hereinbefore, the source audio signals 215 may, alternatively, be considered and/or referred to as channels of a single source audio signal 215.

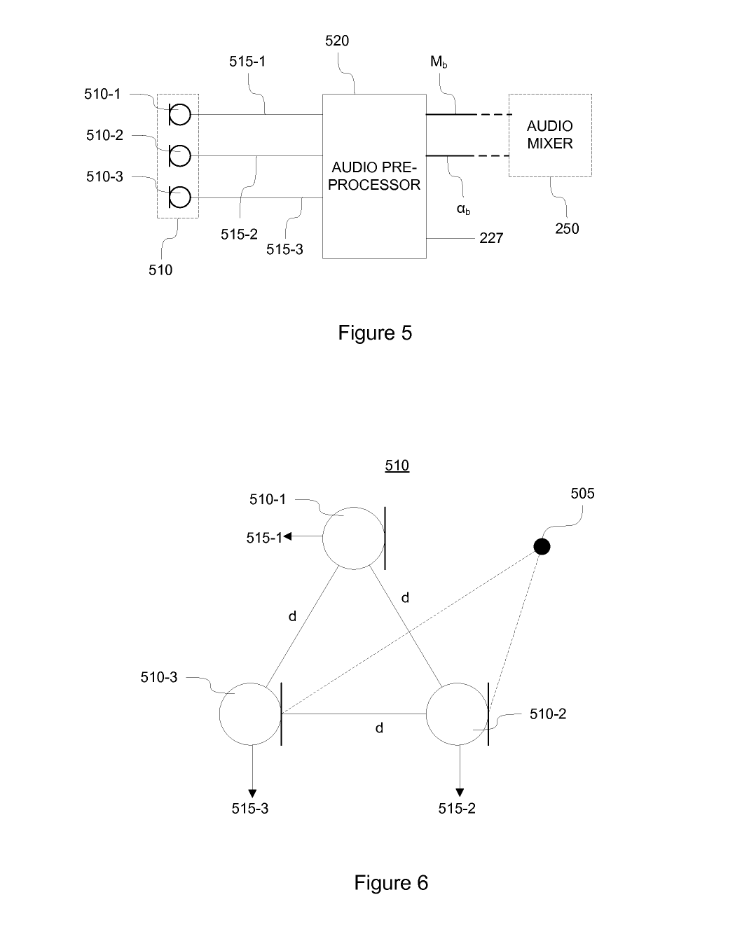

This technique involves estimating the direction of arriving sound independently for B frequency sub-bands in a frequency-domain on basis of a source audio signal captured by a microphone array comprising three microphones. The idea is to find the direction of the perceptually dominating sound source for each frequency sub-band of interest. In this regard, FIG. 5 schematically illustrates an arrangement 500 comprising a microphone array 510 and an audio pre-processor 520. The microphone array 510 may operate as the microphone array 210 of the arrangement 200 and the audio pre-processor 520 may operate as the audio preprocessor 220 of the arrangement 200.

The microphone array 510 comprises three microphones 510-1, 510-2, and 510-3 arranged on a plane (e.g., horizontal level) in the geometrical shape of a triangle with vertices separated by distance, d, as schematically illustrated in FIG. 6. However, this technique described herein generalizes into different microphone setups and geometry. Typically, all the microphones are able to capture sound events from all directions, i.e., the microphones 510-1, 510-2, 510-3 are omnidirectional microphones. Each microphone produces typically an analog signal, which is transformed into a corresponding digital (sampled) audio signal 515-1, 515-2, 515-3 before provision to the audio pre-processor 520.

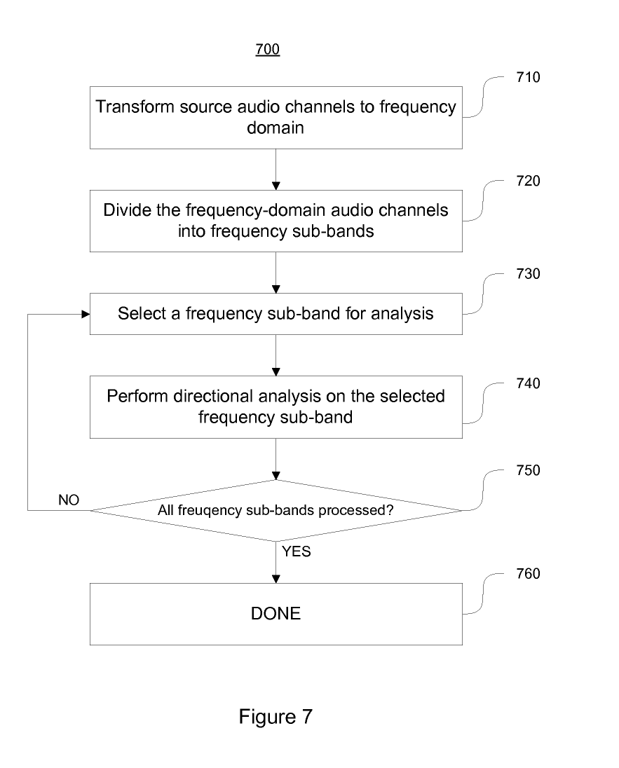

In the following, exemplifying operation of the audio pre-processor 520 is described in parallel with the corresponding method 700, illustrated in FIG. 7.

The audio pre-processor 520 is arranged to analyze the source audio signals 515-1, 515-2, 515-3, respectively, as source audio channels i=1, 2, 3. The audio pre-processor 520 is configured to transform the source audio channels to the frequency domain using the DFT (block 710 in FIG. 7). As an example, sinusoidal analysis window of Nₛ samples with 50 percent overlap between successive analysis frames and effective length of 20 ms may be used for the DFT. Before the DFT transform is applied to the source audio channels in digitized form, Dₜₒₜ=Dₘₐₓ+D_{PROC} zeroes are appended at the end of the analysis window. Dₘₐₓ corresponds to the maximum delay (in samples) between the source audio channels, which is characteristics of the applied microphone setup. In the exemplifying microphone setup illustrated in FIG. 6, the maximum delay is obtained as

$${D}_{max} = \frac{d {F}_{s}}{v} , \qquad ( 5 )$$

wherein Fₛ represents the sampling rate (i.e. the sampling frequency) of the source audio channels and wherein v represents the speed of the sound in the air. D_{PROC} represents the maximum delay caused to the signal by processing applied to the source audio channel, such as filtering of the audio channel or (other) head related transfer function (HRTF) processing. In case no processing is (to be) applied or there is no delay associated with the processing, D_{PROC} may be set to a zero value. After the DFT transform, the frequency domain representation Xₖ(n) results for all three source audio channels, i=1, . . 3, n=0, . . . , N−1, corresponding to the source audio signals 515-1, 515-2, 515-3, respectively. N is the total length of the analysis window considering the sinusoidal window (length Nₛ) and the additional Dₜₒₜ zeroes appended at the end of the analysis window.

The audio pre-processor 520 is configured to divide the frequency domain representations Xₖ(n) of the source audio channels into B frequency sub-bands (block 720 in FIG. 7)

Xᵢ^{b}(n)=Xᵢ(n_{b}+n), n=0, . . . ,n_{b+1}−n_{b}−1, b=0, . . . ,B−1, (6)

where n_{b} denotes the first index of b^{th} frequency sub-band. The widths of the frequency sub-bands can follow, for example, the ERB scale known in the art, as also referred to hereinbefore in context of the audio mixer 250.

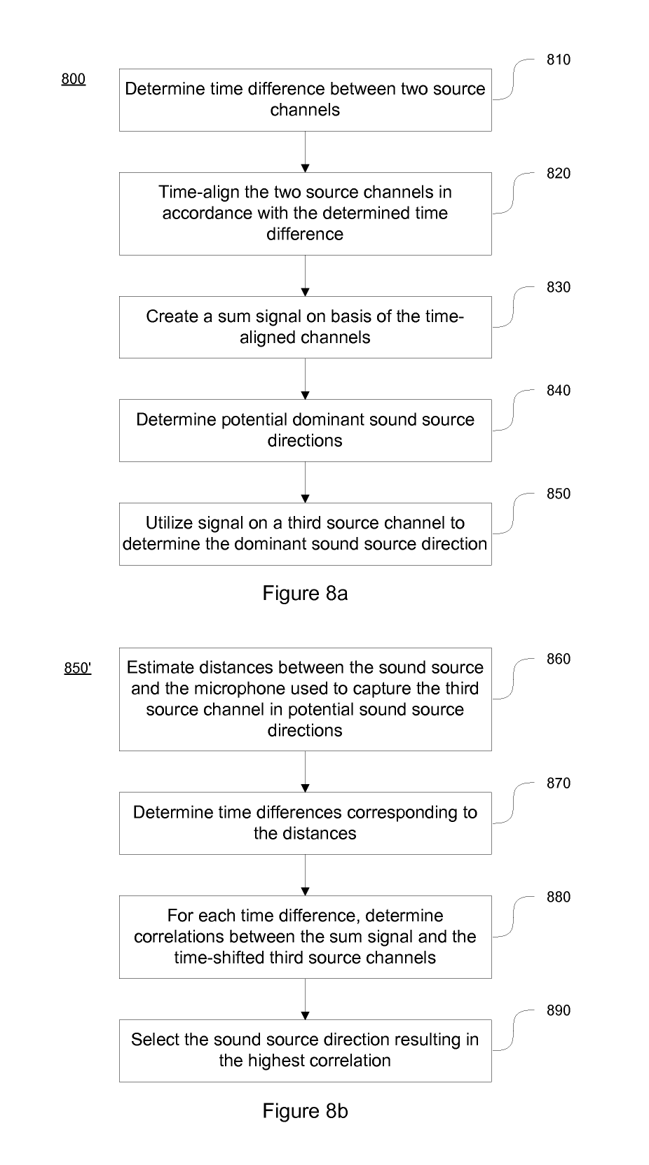

For each frequency sub-band b, the audio pre-processor 520 is configured to perform a directional analysis. As an example, the directional analysis may be performed as described in the following. First, a frequency sub-band is selected (block 730 in FIG. 7), and directional analysis is performed on the respective frequency sub-band signals (block 740 in FIG. 7). Such a directional analysis may determine a dominant sound source direction 226 in form of the angle α_{b}, as described in context of the audio mixer 250. An example of a method for carrying out the directional analysis is provided in FIG. 8. After the directional analysis has been carried out, it is determined if all frequency sub-bands have been processed (block 750 in FIG. 7). If not, the processing continues with selection of the next frequency sub-band (block 730). If so, the directional analysis is complete (block 760 in FIG. 7).

More specifically, the directional analysis for a single frequency sub-band may be performed according to a method 800 illustrated in FIG. 8a, as described in the following. The method 800 may be applied as, for example, the directional analysis referred to in block 740 of the method 700. First the direction is estimated on basis of two source audio channels, described herein for the source audio channels 2 and 3. For the two source audio channels, the time difference between the frequency-domain signals in those channels is determined and compensated for. The time difference compensation comprises finding delay τ_{b} that maximizes the correlation between two source audio channels for frequency sub-band b (block 810 in FIG. 8a) and time-shifting the signal in one or both source audio channels under analysis to time-align the channels (block 820 in FIG. 8a). The frequency domain representation of the corresponding frequency sub-band signal, e.g. Xₖ^{b}(n) can be time-shifted by τ_{b} time domain samples using

$${X}_{k , {τ}_{b}}^{b} ( n ) = {X}_{k}^{b} ( n ) {e}^{- j \frac{2 π n {τ}_{b}}{N}} . \qquad ( 7 )$$

The time difference (also referred to as delay or time delay) can be obtained from

$${max}_{{τ}_{b}} Re ( {\sum }_{n = 0}^{{n}_{b + 1} - {n}_{b} - 1} ( {{X}_{2 , {τ}_{b}}^{b} ( n )}^{*} {X}_{3}^{b} ( n ) ) ) , \\ {τ}_{b} ∈ [ - {D}_{max} , {D}_{max} ] , \qquad ( 8 )$$

wherein Re(x) indicates a function returning the real part of the argument x and wherein x* denotes complex conjugate of the argument x. X_{2,τ}_{_{b}}^{b} and X₃^{b} are considered vectors with length of n_{b+1}−n_{b}−1 samples. Resolution of one sample is generally suitable for the search of the delay. While herein correlation between the source audio channels is used as a similarity measure, a similarity measure different from correlation, e.g. a perceptually motivated similarity measure, may be employed instead. With the delay information, a sum signal is created (block 830 in FIG. 8a). The sum signal may be constructed e.g. according to

$${X}_{sum}^{b} = \{ \begin{matrix}( {X}_{2 , {τ}_{b}}^{b} + {X}_{3}^{b} ) / 2 & {τ}_{b} \leq 0 \\ ( {X}_{2}^{b} + {X}_{3 , - {τ}_{b}}^{b} ) / 2 & {τ}_{b} > 0\end{matrix} , \qquad ( 9 )$$

where τ_{b} denotes the time difference τ_{b} between the two source audio channels, e.g. as determined in accordance with the equation (8).

In construction of the sum signal, the content (i.e., frequency-domain signal) of the source audio channel in which an event occurs first is, preferably, provided as such, whereas the content (i.e., frequency-domain signal) of the source audio channel in which the event occurs later in time is shifted in time to obtain temporal alignment with the non-shifted source audio channel, i.e. to time-align the two channels. However, it is also possible to time-align the audio channels e.g. by time-shifting the both audio channels such that the sum of the time-shifting equals to the determined time difference τ_{b}. This generalizes into time shifting the one of the audio channels with respect to the other one by the determined time difference τ_{b}. The sum signal Xₛᵤₘ^{b} serves also as the mid-signal M_{b} for the frequency sub-band b.

Referring back to FIG. 6, a simple illustration helps to describe in broad, non-limiting terms, the time-shift according to the time difference τ_{b} and its operation above in the equation (9). A sound source 505 creates an event described by the exemplary time-domain function ƒ₁(t) received at the microphone 510-2 (corresponding to the source audio channel 2). That is, the source audio signal 515-2 would have some resemblance to the time-domain function ƒ₁(t). Similarly, the same event, when received by microphone 510-3 (corresponding to the source audio channel 3) is described by the exemplary time-domain function ƒ₂(t). The microphone 510-3 receives a time-shifted version of ƒ₁(t). In other words, in an ideal scenario, the function ƒ₂(t) is simply a time-shifted version of the function ƒ₁(t), where ƒ₂(t)=f₁(t−τ_{b}). Thus, in one aspect, the time-shifting (or time-alignment) aims to remove a time difference between when an event occurs at one microphone (e.g., microphone 510-3) relative to the occurrence of the event at another microphone (e.g., microphone 510-2). This situation is described as ideal because in reality the two microphones will likely experience different environments, their recording of the event could be influenced by constructive or destructive interference or elements that block or enhance sound from the event, etc.

The time difference τ_{b} serves as an indication how much closer the sound source is to the microphone 510-2 than the microphone 510-3 (e.g. when τ_{b} is positive, the sound source is closer to the microphone 510-2 than the microphone 510-3). The difference in distances from the microphone 510-2 and from the microphone 510-3 may be, in turn, applied to determine the direction of arrival of the sound captured by the microphones 510-2 and 510-3. Consequently, a predetermined mapping function may be applied to determine an indication of the sound source direction on basis of the time difference τ_{b}. A number of different mapping functions may be applied in this regard. In the following an exemplifying mapping is described. According to this example, the actual difference in distance can be calculated e.g. as

$${Δ}_{23} = \frac{v {τ}_{b}}{{F}_{s}} . \qquad ( 10 )$$

Utilizing basic geometry on the microphone setup in FIG. 6, the audio preprocessor 520 may be configured to determine that the potential angle of the arriving sound is equal to (block 840 in FIG. 8a)

$${\dot{α}}_{b} = \pm {cos}^{- 1} ( \frac{{Δ}_{23}^{2} + 2 b {Δ}_{23} - {d}^{2}}{2 db} ) . \qquad ( 11 )$$

where d is the distance between microphones and b is the estimated distance between sound source and nearest microphone. Typically, b can be set to a fixed value. For example b=2 meters has been found to provide stable results. Notice that the angle \dot{α}_{b} derived by the equation (11) represents two alternatives for the direction of the arriving sound, i.e. two potential sound source directions, as it may not be possible to determine the exact direction based on only two microphones.

Therefore, the microphone setup illustrated in FIG. 6 employs a third microphone, which may be utilized to define which of the signs, i.e. plus or minus, in the equation (11) is correct (block 850 in FIG. 8). An example of a technique for defining the correct sign in the equation (11) is described in the following, also depicted in FIG. 8b illustrating a method 850′.

First, the distances between microphone 510-1 and the sound source in the two potential dominant sound source directions (represented by the plus and the minus in the equation (11)) are estimated e.g. by using the following equations (block 860 in FIG. 8b)

$${δ}_{b}^{+} = \sqrt{{( h + b sin ( {\dot{α}}_{b} ) )}^{2} + {( \frac{d}{2 + b cos ( {\dot{α}}_{b} )} )}^{2}} \\ {δ}_{b}^{-} = \sqrt{{( h - b sin ( {\dot{α}}_{b} ) )}^{2} + {( \frac{d}{2 + b cos ( {\dot{α}}_{b} )} )}^{2}} , \qquad ( 12 )$$

where h is the height of the equilateral triangle, i.e.

$$h = \frac{\sqrt{3}}{2} d . \qquad ( 13 )$$

The distances in the equation (12) may be converted into respective time differences (expressed in this example as the number of samples of the digitized audio signal) by (block 870 in FIG. 8)

$${τ}_{b}^{+} = \frac{{δ}^{+} - b}{v} {F}_{s} \\ {τ}_{b}^{-} = \frac{{δ}^{-} - b}{v} {F}_{s} , \qquad ( 14 )$$

Out of these two time differences, the one providing a higher correlation with the sum signal is selected. These correlations may be obtained e.g. using the following equations (block 880 in FIG. 8b):

c_{b}⁺Re(Σₙ₌₀ⁿ^{_{b+1}}⁻ⁿ^{_{b}}⁻¹(X_{sum,τb}_{⁺}(n)*X₁^{b}(n)))

c_{b}⁻Re(Σₙ₌₀ⁿ^{_{b+1}}⁻ⁿ^{_{b}}⁻¹(X_{sum,τb}_{^{−}}(n)*X₁^{b}(n))). (15)

Now, the direction of the dominant sound source for the frequency sub-band b may be obtained by selecting the one providing a higher correlation (block 890 in FIG. 8b), e.g. according to

$${α}_{b} = \{ \begin{matrix}{\dot{α}}_{b} & {c}_{b}^{+} \geq {c}_{b}^{-} \\ - {\dot{α}}_{b} & {c}_{b}^{+} < {c}_{b}^{-}\end{matrix} . \qquad ( 16 )$$

While the description hereinbefore exemplifies the audio pre-processor 520 configured to create the mid-signal as the primary audio signal 225 and the indications of the dominant sound source directions 226, the audio pre-processor 520 may be further arranged to create channels of a 5.1 channel surround audio signal as the supplementary audio signals 227 on basis of the set of source audio signals 215. An example in this regard is described in the following.

In this regard, along similar lines as described for the sum signal Xₛᵤₘ^{b} in context of the equation (9), the sum signal also serving as the mid-signal, also a difference signal may be constructed, e.g. according to

$${X}_{diff}^{b} = \{ \begin{matrix}( {X}_{2 , {τ}_{b}}^{b} - {X}_{3}^{b} ) / 2 & {τ}_{b} \leq 0 \\ ( {X}_{2}^{b} - {X}_{3 , - {τ}_{b}}^{b} ) / 2 & {τ}_{b} > 0\end{matrix} . \qquad ( 17 )$$

As in case of the sum signal Xₛᵤₘ^{b}, also the difference signal X_{diff}^{b} is preferably constructed such that the content (i.e., frequency-domain signal) of the source audio channel in which an event occurs first is provided as such, whereas the content (i.e., frequency-domain signal) of the source audio channel in which the event occurs later is shifted in time to obtain temporal match with the non-shifted source audio channel. The difference signal X_{diff}^{b} serves also as the side-signal S_{b} for the frequency sub-band b.

While described hereinbefore for a single frequency sub-band b, the same estimation process to derive the sum signal Xₛᵤₘ^{b}, the angles α_{b} indicating the dominant sound source directions and possibly the difference signal X_{diff}^{b} is repeated for each frequency sub-band of interest.

The audio pre-processor 520 may be further configured to employ the sum signals Xₛᵤₘ^{b}, the difference signals X_{diff}^{b} and the angles α_{b} as basis for generating channels of a 5.1 channel surround audio signal serving as the supplementary audio signals 227 for provision to the encoding entity 280. The 5.1 channel surround audio signal, namely the center channel (C), the front-left channel (F_L), the front-right channel (F_R), rear-left channel (R_L) and the rear-right (R_R) channel, may be generated for example as described in the patent publication number WO2013/024200 from paragraph 130 to paragraph 147 (incl. the equations (24) to (34)), incorporated herein by reference. In particular, with reference to the description provided in this portion of WO2013/024200, the sum signals Xₛᵤₘ^{b} are applied as the mid signal M^{b}, the difference signal X_{diff}^{b} is applied as the side signal S^{b}, and the angles α_{b} correspond to the directional information α^{b}.

As an example, this may involve determining the above-mentioned channels of the 5.1 channel surround audio signal as sum of respective directional signal components and ambient components. For a given frequency sub-band of a given channel of the 5.1 channel surround audio signal, the directional signal component may be determined by multiplying the respective frequency band signal Xₛᵤₘ^{b} by a predetermined gain factor g_{X}^{b} or ĝ_{X}^{b}, e.g. as described in context of the equations (24) to (31) of WO2013/024200. Hence, the gain factor g_{X}^{b} or ĝ_{X}^{b} is associated with the given channel of the 5.1 channel surround audio signal and the dominant sound source direction for the given frequency sub-band. The respective ambient signal component may be derived by filtering the difference signal X_{diff}^{b} of the given frequency sub-band by a predetermined decorrelation filter, e.g. as described in context of equations (32) and (33) of WO2013/024200.

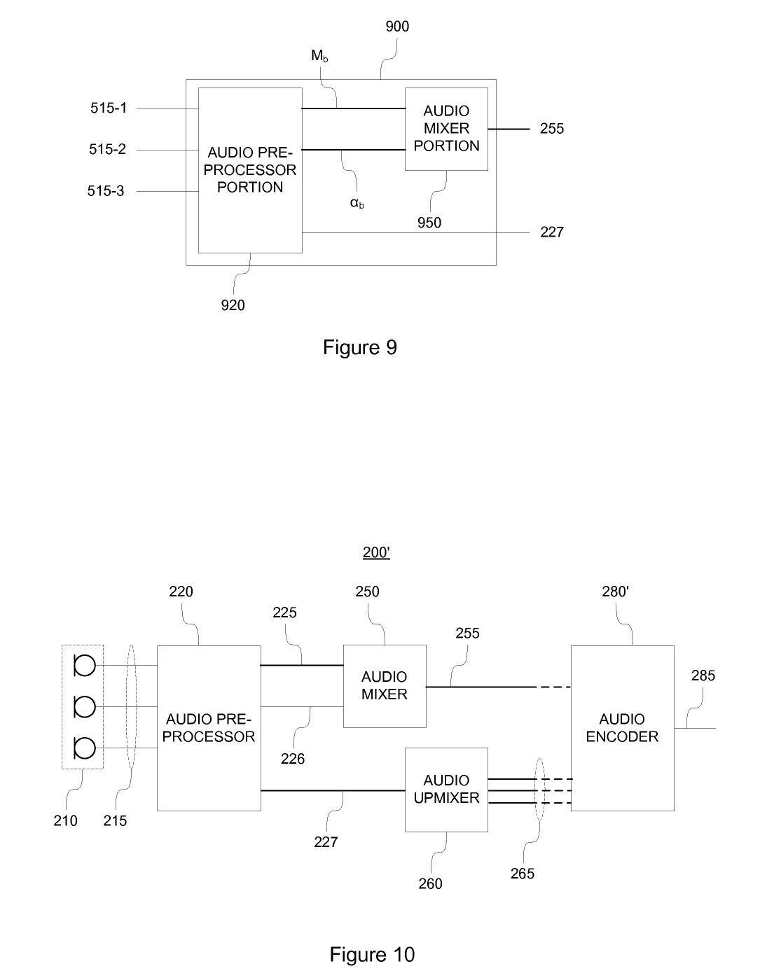

In other embodiments the audio pre-processor 520 and the audio mixer 250 may be provided as an audio processing entity 900 comprising an audio pre-processing portion 920 and an audio mixer portion 950, as schematically illustrated in FIG. 9. The pre-processing portion 920 and the audio mixer portion 950 may be configured to operate as described hereinbefore in context of the audio pre-processor 520 and the audio mixer 250, respectively. Consequently, the input provided to the audio processing entity 900 is the set of source audio signals 515 whereas the output of the audio processing entity 900 comprises the one or more audio objects 255. The output of the audio processing entity 900 may further comprise the supplementary audio signal(s) 227 for provision to the audio encoding entity 280. The audio processing entity 900 may replace the audio pre-processor 220 and the audio mixer 250 in the arrangement 200.

The audio encoding entity 280 of the arrangement 200, may comprise, for example, a DOLBY ATMOS audio encoding entity, as described e.g. in the white paper “Dolby® Atmos™, Next-Generation Audio for Cinema” and/or in the document “Authoring for Dolby® Atmos™ Cinema Sound Manual”, Issue 1, Software v1.0, Part Number 9111800, 513/26440/26818. Such an audio encoding entity may operate on basis of the audio objects 255 only, or the audio encoding entity may additionally make use of channels of a 5.1 channel surround audio signal, e.g. as provided as the supplementary audio signal(s) 227 as an output from the audio preprocessor 220 or the audio pre-processor 520. ¹ as downloadable on 5 Jun. 2013 at http://www.dolby.com/us/en/professional/technology/cinema/dolby-atmos-creators.html

As another example, the audio encoding entity 280 may comprise an audio encoder according to the MPEG SAOC standard “ISO/IEC 23003-2—Information technology—MPEG audio technologies—Part 2: Spatial Audio Object Coding (SAOC)”, Edition 1, Stage 60.60 (2010 Oct. 6). Such an audio encoding entity may operate on basis of the audio objects 255 only, or the audio encoding entity may additionally make use of channels of a 5.1 channel surround audio signal, e.g. as provided as the supplementary audio signal(s) 227 as an output from the audio preprocessor 220 or the audio pre-processor 520.

FIG. 10 schematically illustrates an arrangement 200′, which is a variation of the arrangement 200 depicted in FIG. 2. The arrangement 200′ is otherwise similar to the arrangement 200, but it further comprises an audio upmixing entity 260. The audio upmixing entity 260 is configured to receive the supplementary audio signal(s) 227 from the audio pre-processor 220, to upmix the set of supplementary audio signals 227 in accordance with a predetermined rule into upmixed supplementary audio signals 265 including a higher number of audio channels/signals than the supplementary audio signals 227 and to provide the upmixed supplementary audio signals 265 for the audio rendering entity 280′. As in case of the arrangement 200, also in the arrangement 200′ the microphone array 210 may comprise the microphone array 510 and/or the audio pre-processor 220 may comprise the audio pre-processor 520. As an exemplifying variation of the arrangement 200′, the audio pre-processor 220 and the audio mixer 250 may be replaced by the audio processing entity 900.

The audio upmixing entity 260 may be arranged to apply a predetermined rule providing the upmixed supplementary audio signals 265 in a format according to AURO 3D sound format. In particular, the audio upmixing entity 260 may be configured to employ AUROMATIC upmixing algorithm by AURO TECHNOLOGIES. Consequently, the audio encoding entity 280′ may comprise an AURO 3D OCTOTPUS encoder. The AURO 3D sound in general, the AUROMATIC and the AURO 3D OCTOPUS encoder are described for example in the white paper Bert Van Daele, Wilfried Van Baelen, “Auro-3D Octopus Codec, Principles behind a revolutionary codec”, Rev. 2.7, 17 Nov. 2011.

The operations, procedures, functions and/or methods described in context of the audio pre-processor 220, 520 and/or the audio mixer 250 (or in context of the audio pre-processing portion 920 and the audio mixer portion 950) may be distributed between these processing entities (or portions) in a manner different from the one(s) described hereinbefore. There may be, for example, further entities (or portions) for carrying out some of the operations procedures, functions and/or methods assigned in the description hereinbefore to the audio pre-processor 220, 520 and/or the audio mixer 250 (or to the audio pre-processing portion 920 and the audio mixer portion 950), or there may be a single portion or unit for carrying out the operations, procedures, functions and/or methods described in context of the audio pre-processor 220, 520 and/or the audio mixer 250 (or in context of the audio pre-processing portion 920 and the audio mixer portion 950).

In particular, the operations, procedures, functions and/or methods described in context of the audio pre-processor 220, 520 and/or the audio mixer 250 (or in context of the audio pre-processing portion 920 and the audio mixer portion 950) may be provided as software means, as hardware means, or as a combination of software means and hardware means. As an example in this regard, the audio mixer 250 or the audio mixer portion 950 may be provided as an apparatus comprising means for obtaining a plurality of frequency sub-band signals M_{b}, each representing a directional component of the source audio signal 215 in the respective frequency sub-band b, means for obtaining an indication of dominant sound source direction 226 for one or more of said frequency sub-band signals M_{b}, and means for creating one or more audio objects 255 on basis of said plurality of frequency sub-band signals M_{b} and said indications, the means for creating arranged to derive one or more audio object signals Cₖ, each audio object signal Cₖ comprising a respective directional signal C_{d,k} determined on basis of frequency sub-band signals M_{b} for which dominant sound source direction 226 falls within a respective predetermined range of source directions and to derive one or more audio object direction indications tₖ for said one or more audio object signals, each audio object direction indication tₖ derived on basis of dominant sound source directions 226 for the frequency subband signals M_{b} used for determining the respective directional signal C_{d,k}.

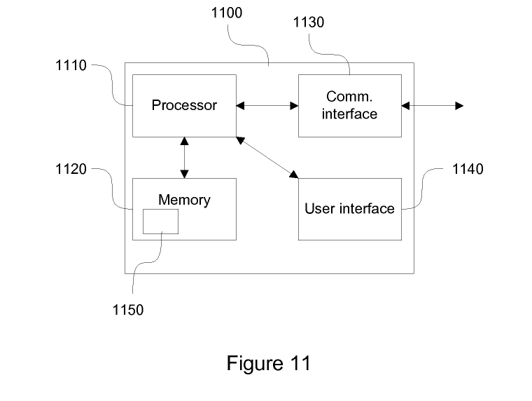

FIG. 11 schematically illustrates an exemplifying apparatus 1100 upon which an embodiment of the invention may be implemented. The apparatus 1100 as illustrated in FIG. 11 provides a diagram of exemplary components of an apparatus, which is capable of operating as or providing the gesture the audio pre-processor 220, 520 and/or the audio mixer 250 (or the audio processing entity 900) according to an embodiment. The apparatus 1100 comprises a processor 1110, a memory 1120 and a communication interface 1130, such as a network card or a network adapter enabling wireless or wireline communication with another apparatus and/or radio transceiver enabling wireless communication with another apparatus over radio frequencies. The processor 1110 is configured to read from and write to the memory 1120. The memory 1120 may, for example, act as the memory for storing the source audio signals 215, the primary audio signals 225, the direction indications 226, the secondary audio signal(s) 227 and/or the audio objects 255. The apparatus 1100 may further comprise a user interface 1140 for providing data, commands and/or other input to the processor 1110 and/or for receiving data or other output from the processor 1110, the user interface 1140 comprising for example one or more of a display, a keyboard or keys, a mouse or a respective pointing device, a touchscreen, etc. The apparatus 1100 may comprise further components not illustrated in the example of FIG. 11.

Although the processor 1110 is presented in the example of FIG. 11 as a single component, the processor 1110 may be implemented as one or more separate components. Although the memory 1120 in the example of FIG. 11 is illustrated as a single component, the memory 1120 may be implemented as one or more separate components, some or all of which may be integrated/removable and/or may provide permanent/semi-permanent/dynamic/cached storage.

The apparatus 1100 may be embodied for example as a mobile phone, a digital camera, a digital video camera, a music player, a gaming device, a laptop computer, a desktop computer, a personal digital assistant (PDA), a tablet computer, etc.—basically as any apparatus that is able to process captured source audio signals 215 or that may be (re-)configured to be able to process captured source audio signals 215.

The memory 1120 may store a computer program 1150 comprising computer-executable instructions that control the operation of the apparatus 1100 when loaded into the processor 1110. As an example, the computer program 1150 may include one or more sequences of one or more instructions. The computer program 1150 may be provided as a computer program code. The processor 1110 is able to load and execute the computer program 1150 by reading the one or more sequences of one or more instructions included therein from the memory 1120. The one or more sequences of one or more instructions may be configured to, when executed by one or more processors, cause an apparatus, for example the apparatus 1100, to implement the operations, procedures and/or functions described hereinbefore in context of the audio pre-processor 220, 520 and/or the audio mixer 250 (or the audio processing entity 900).

Hence, the apparatus 1100 may comprise at least one processor 1110 and at least one memory 1120 including computer program code for one or more programs, the at least one memory 1120 and the computer program code configured to, with the at least one processor 1110, cause the apparatus 1100 to perform the operations, procedures and/or functions described hereinbefore in context of the audio pre-processor 220, 520 and/or the audio mixer 250 (or the audio processing entity 900).

The computer program 1150 may be provided at the apparatus 1100 via any suitable delivery mechanism. As an example, the delivery mechanism may comprise at least one computer readable non-transitory medium having program code stored thereon, the program code which when executed by an apparatus cause the apparatus at least implement processing to carry out the operations, procedures and/or functions described hereinbefore in context of the audio pre-processor 220, 520 and/or the audio mixer 250 (or the audio processing entity 900). The delivery mechanism may be for example a computer readable storage medium, a computer program product, a memory device a record medium such as a CD-ROM or DVD or another article of manufacture that tangibly embodies the computer program 1150. As a further example, the delivery mechanism may be a signal configured to reliably transfer the computer program 1150.

Reference to a processor should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

1. An apparatus comprising at least one processor and at least one memory including computer program code for one or more programs, the at least one memory and the computer program code configured to, with the at least one processor, cause the apparatus to:
obtain a plurality of frequency sub-band signals, each representing a directional component of a source audio signal in the respective frequency sub-band;
obtain an indication of dominant sound source direction for one or more of said frequency sub-band signals; and
create one or more audio objects on basis of said plurality of frequency sub-band signals and said indications, wherein the apparatus caused to create one or more objects is further caused to:
derive one or more audio object signals, each audio object signal comprising a respective directional signal determined on basis of frequency sub-band signals for which dominant sound source direction falls within a respective predetermined range of source directions; and
derive one or more audio object direction indications for said one or more audio object signals, each audio object direction indication derived on basis of dominant sound source directions for the frequency sub-band signals used to determine the respective directional signal.

2. An apparatus according to claim 1, wherein said predetermined ranges of source directions are defined as respective predefined non-overlapping sectors of a horizontal circle centered at the assumed listening point.

3. An apparatus according to claim 2, wherein said predefined sectors cover said horizontal circle in full.

4. An apparatus according to claim 1, wherein a directional signal is determined as a sum of frequency sub-band signals for which dominant sound source direction falls within the respective predetermined range of source directions.

5. An apparatus according to claim 1, wherein an audio object direction indication is determined as an average of dominant sound source directions for the frequency sub-band signals used for determining the respective directional signal.

6. An apparatus according to claim 5, wherein a direction is indicated as an angle with respect to a reference direction and wherein said average is determined as an average of angles indicating said dominant sound source directions.

7. An apparatus according to claim 1, wherein an audio object signal is derived further on basis of a non-directional signal determined on basis of frequency sub-band signals for which no direction of dominant sound source is indicated, wherein said non-directional signal is determined as a sum of frequency sub-band signals for which no direction of dominant sound source is indicated, divided by the number of predetermined ranges of source directions, and wherein an audio object signal is derived as a sum of the respective directional and non-directional signals.

8. An apparatus according to claim 1, wherein said frequency sub-band signals represent a mid-signal of a mid/side decomposition of the source audio signal.

9. An apparatus according to claim 1, wherein the apparatus is further caused to determine, for said plurality of frequency sub-bands, a time delay between a first audio channel and a second audio channel of the source audio signal in the respective frequency sub-band, and
wherein the apparatus caused to obtain said plurality of frequency sub-band signals is further caused to, for each of the plurality of frequency sub-band signals:
time-shift the first audio channel in relation to the second audio channel by the determined time delay to time-align the first and second audio channels; and
derive the respective frequency sub-band signal as an average of the time-aligned first and second audio channels; and
wherein the apparatus caused to obtain said indications is further caused to apply, for said plurality of frequency sub-bands, a predetermined mapping function for deriving the indication of dominant sound source direction on basis of the determined time delay.

10. An apparatus according to claim 9, wherein the apparatus caused to apply said predetermined mapping function is further caused to:
determine two potential dominant sound source directions on basis of the determined time delay;
time-shift the respective frequency sub-band signal by two different time differences that dependent on the two potential dominant sound source directions to create two time-shifted frequency sub-band signals;
determine which of the two time-shifted frequency sub-band signals has is more correlated with a third channel of the source audio signal in the respective frequency sub-band; and
select the potential dominant sound source direction resulting in a better correlation as the dominant sound source direction for the respective frequency sub-band.

11. An apparatus according to claim 8, further caused to extract, from the source audio signal, one or more supplementary signals representing the ambient component of the source audio signal.

12. An apparatus according to claim 11, wherein said one or more supplementary signals comprise channels of a 5.1 channel surround audio signals,
wherein the apparatus is further caused to derive, for each of the plurality of frequency sub-bands, a difference signal as the difference of the time-aligned first and second audio channels divided by two, and
wherein each channel of said 5.1 channel surround audio signal is derived on basis of directional signal components derived on basis of the frequency sub-band signals and ambient signal components derived on basis of the difference signals.

13. An apparatus according to claim 12, wherein, for each frequency sub-band of each channel of the 5.1 channel surround audio signal,
the directional signal component is derived by multiplying the respective frequency band signal by a predetermined gain factor, which gain factor is associated with the respective channel of the 5.1 channel surround audio signal and the dominant sound source direction for the respective frequency sub-band. and
the ambient signal component is derived by filtering the difference signal of the respective frequency sub-band by a predetermined decorrelation filter, and
wherein the each channel of the 5.1 channel surround audio signal is derived as the sum of the respective directional and ambient signal components.

14. A method comprising:
obtaining a plurality of frequency sub-band signals, each representing a directional component of a source audio signal in the respective frequency sub-band;
obtaining an indication of dominant sound source direction for one or more of said frequency sub-band signals; and
creating one or more audio objects on basis of said plurality of frequency sub-band signals and said indications, said creating comprising:
deriving one or more audio object signals, each audio object signal comprising a respective directional signal determined on basis of frequency sub-band signals for which dominant sound source direction falls within a respective predetermined range of source directions; and
deriving one or more audio object direction indications for said one or more audio object signals, each audio object direction indication derived on basis of dominant sound source directions for the frequency sub-band signals used for determining the respective directional signal.

15. A method according to claim 14, wherein said predetermined ranges of source directions are defined as respective predefined non-overlapping sectors of a horizontal circle centered at the assumed listening point.

16. A method according to claim 15, wherein said predefined sectors cover said horizontal circle in full.

17. A method according to claim 14, wherein a directional signal is determined as a sum of frequency sub-band signals for which dominant sound source direction falls within the respective predetermined range of source directions.

18. A method according to claim 14, wherein an audio object direction indication is determined as an average of dominant sound source directions for the frequency sub-band signals used for determining the respective directional signal.

19. A method according to claim 18, wherein a direction is indicated as an angle with respect to a reference direction and wherein said average is determined as an average of angles indicating said dominant sound source directions.

20. A method according to claim 14, wherein an audio object signal is derived further on basis of a non-directional signal determined on basis of frequency sub-band signals for which no direction of dominant sound source is indicated, wherein said non-directional signal is determined as a sum of frequency sub-band signals for which no direction of dominant sound source is indicated, divided by the number of predetermined ranges of source directions, and wherein an audio object signal is derived as a sum of the respective directional and non-directional signals.

21. A method according to claim 14, wherein said frequency sub-band signals represent a mid-signal of a mid/side decomposition of the source audio signal.

22. A method according to claim 14, further comprising determining, for said plurality of frequency sub-bands, a time delay between a first audio channel and a second audio channel of the source audio signal in the respective frequency sub-band,
wherein obtaining said plurality of frequency sub-band signals comprises, for each of the plurality of frequency sub-band signals,
time-shifting the first audio channel in relation to the second audio channel by the determined time delay to time-align the first and second audio channels, and
deriving the respective frequency sub-band signal as an average of the time-aligned first and second audio channels, and
wherein obtaining said indications comprises applying, for said plurality of frequency sub-bands, a predetermined mapping function for deriving the indication of dominant sound source direction on basis of the determined time delay.

23. A method according to claim 22, wherein applying said predetermined mapping function comprises:
determining two potential dominant sound source directions on basis of the determined time delay:
time-shifting the respective frequency sub-band signal by two different time differences that dependent on the two potential dominant sound source directions to create two time-shifted frequency sub-band signals:
determining which of the two time-shifted frequency sub-band signals has is more correlated with a third channel of the source audio signal in the respective frequency sub-band: and
selecting the potential dominant sound source direction resulting in a better correlation as the dominant sound source direction for the respective frequency sub-band.

24. A method according to claim 21, further comprising extracting, from the source audio signal, one or more supplementary signals representing the ambient component of the source audio signal.

25. A method according to claim 24, wherein said one or more supplementary signals comprise channels of a 5.1 channel surround audio signals,
wherein the method further comprises deriving, for each of the plurality of frequency sub-bands, a difference signal as the difference of the time-aligned first and second audio channels divided by two, and
wherein each channel of said 5.1 channel surround audio signal is derived on basis of directional signal components derived on basis of the frequency sub-band signals and ambient signal components derived on basis of the difference signals.

26. A method according to claim 25, wherein, for each frequency sub-band of each channel of the 5.1 channel surround audio signal,
the directional signal component is derived by multiplying the respective frequency band signal by a predetermined gain factor, which gain factor is associated with the respective channel of the 5.1 channel surround audio signal and the dominant sound source direction for the respective frequency sub-band, and
the ambient signal component is derived by filtering the difference signal of the respective frequency sub-band by a predetermined decorrelation filter, and
wherein the each channel of the 5.1 channel surround audio signal is derived as the sum of the respective directional and ambient signal components.
